(19) United States
(12) Patent Application Publication
(10) Pub. No.: US 2009/0173459 A1
(43) Pub. Date: Jul. 9, 2009

(54) CURTAIN ASSEMBLY

(76) Inventors: Sheng Ying HSU, Fuxing Shiang (TW); Wu Chung NIEN, Fuxing Shiang (TW)

Correspondence Address: PHILLIP LIU, 6980, WHITEOAK DRIVE, RICHMOND, V7E4Z9, omitted

(21) Appl. No.: 12/404,293

(22) Filed: Mar. 14, 2009

Related U.S. Application Data
(63) Continuation-in-part of application No. 11/520,603, filed on Sep. 14, 2006.

(51) Int. Cl. E06B 9/00

(52) U.S. Cl. 160/331

(57) ABSTRACT

A curtain assembly includes a first control unit received in the top box, a bottom box in which a second control unit is received, a shade connected between the top bar and the bottom box. Each of the first and second control units includes a fixed member, a movable member and a control member, a rope is wrapped around pulleys in the fixed member and the movable member, and another rope has one end fixed to the movable member and the other end of the rope is wrapped around a spring coil member in the control member. The shade is stretched or collected by moving the bottom box. The top bar is moved away from the top box to define an opened space between the top box and the top bar.

This is a Continuation-In-Part patent application of applicant's former application Ser. No. 11/520,603, filed on Sep. 14, 2006.

### FIELD OF THE INVENTION

### Background of the Invention

A conventional window blinds assembly usually comprises multiple slats connected by control ropes which are connected to control mechanism received in the top box of the blinds assembly. The users operate the control ropes to change the angles of the slats to introduce light outside into the room. The slats can also be collected upward by operation of the ropes. Another type of the window blinds assembly does not include the control ropes and the users can hold the bottom bar and drag or push the slats to adjust the covering of the window.

For the rope-less blinds assembly, the users have to push all the slats upward until all the slats are collected beneath the top box, when the users want to see the outside scenes through the window. However, for some users such as the customers sit beside the window of a restaurant, they do not want people to watch them using their meals, so that they prefer to partially cover the window while they can still enjoy the scene outside. In this case, the customers prefer to adjust the blinds at lower portion of the window and they can see through the window via the top portion of the blinds.

The present invention intends to provide a curtain assembly which allows the user to drag the top bar to a distance from the top box so that the lower portion of the window is covered and the users can see through the top portion of the window.

### SUMMARY OF THE INVENTION

The present invention relates to a curtain assembly which includes a top box having a first control unit received in the first space thereof, a top bar located beneath the top box, an expandable shade connected between the top bar and a bottom box, and a bottom box in which a second control unit is received. The first control unit includes a first fixed member, a first movable member and a first control member, wherein the fist movable member is located between the first fixed member and the first control member. A first rope is wrapped around pulleys in the first fixed member and the first movable member. Two ends of the first rope extend through the top box and are fixed to the top bar. A second rope has a first end fixed to the first movable member and a second end of the second rope is wrapped around a spring coil member in the first control member so that the spring coil member drags the second rope to move the movable member away from the first fixed member.

The top bar includes a top layer and a bottom layer, two passing holes are defined through the top layer and the bottom layer of the top bar respectively. The two ends of the first rope extend through the top box and the two passing holes in the top layer of the top bar and are fixed to two ends of the top bar.

The second control unit includes the same parts as the first control unit, except for that the two ends of the third rope which is wrapped between pulleys of the fixed member and the movable member of the second control unit, extend through the bottom box, the expandable shade, the top bar and are fixed to the top box. The expandable shade is stretched or collected by moving the bottom box.

The top bar can be pulled away from the top box to define an open space between the top bar and the top box.

The primary object of the present invention is to provide a rope-less curtain assembly which has a top bar located between the top end of the expandable shade and the top box, and the top bar is able to be moved away from the top box to define an open space between the top box and the top bar.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the curtain assembly of the present invention, wherein the expandable shade is collected;

FIG. 2 is an exploded view to show the curtain assembly of present invention;

FIG. 3 is a perspective view to show the curtain assembly of the present invention, wherein the expandable shade is partially collected;

FIG. 4 shows that the top bar is moved away from the top box to define an open space between the top box and the top bar, and

FIG. 5 shows an operation wand is to be connected to the bottom box of the curtain assembly of the present invention.

### DETAILED DESCRIPTION OF THE PREFERRED EMBODIMENT

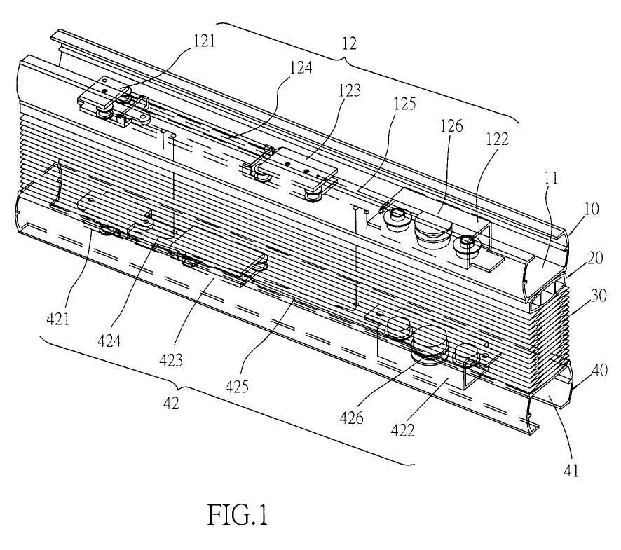

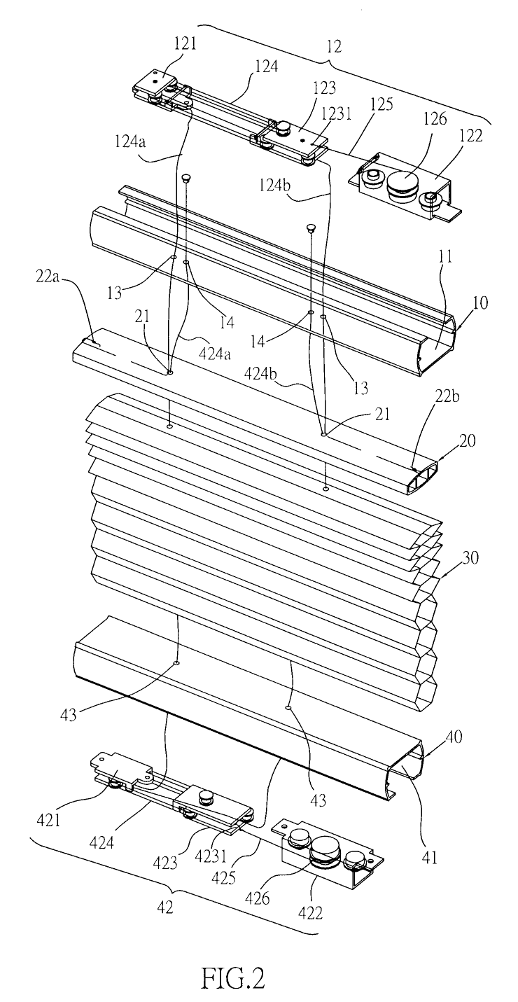

Referring to FIGS. 1 and 2, the curtain assembly of the present invention comprises a top box 10, a top bar 20, an expandable shade 30 and a bottom box 40. The top box 10 has a first space 11 defined therein and a first control unit 12 is received in the first space 11. The first control unit 12 includes a first fixed member 121, a first movable member 123 and a first control member 122. The fist movable member 123 is located between the first fixed member 121 and the first control member 122. A first rope 124 is wrapped around pulleys in the first fixed member 121 and the first movable member 123. Two ends 124a, 124b of the first rope 124 extend through two through holes 13 in the top box 10. The top bar 20 is located below the top box 10 and includes a top layer and a bottom layer. Two passing holes 21 are defined through the top layer and the bottom layer of the top bar 20 respectively. The two ends 124a, 124b of the first rope 124 extend through the two through holes 13 in the top box 10 and the two passing holes 21 in the top layer of the top bar 20 and are fixed to two ends of the top bar 20 at positions 22a and 22b.

A second rope 125 has a first end fixed to the first movable member 123 at a position 1231 and a second end of the second rope 125 is wrapped around a spring coil member 126 in the first control member 122. The spring coil member 126 uses its spring force to drag the second rope 125 to move the movable member 123 away from the first fixed member 121.

The expandable shade 30 has a top end fixed to an underside of the top bar 20 and a bottom end of the expandable shade 30 is fixed to the bottom box 40. The bottom box 40 includes a second space 41 and a second control unit 42 is received in the second space 41 of the bottom box 40. The second control unit 42 includes a second fixed member 421, a second movable member 423 and a second control member 422, the second movable member 423 is located between the second fixed member 421 and the second control member 422. A third rope 424 is wrapped around pulleys in the second fixed member 421 and the second movable member 423. Two ends 424a, 424b of the third rope 424 extend through two second through holes 43 in the bottom box 40, the expandable shade 30, the two passing holes 21 in the top bar 20 and are fixed to the first through holes 13 in the top box 10 by two washers. A fourth rope 425 has a first end fixed to the second movable member 423 at a position 4231 and a second end of the fourth rope 425 is wrapped around a second spring coil member 426 in the second control member 422. The second spring coil member 426 of the second control unit 42 tends to drag the fourth rope 425 to move the second movable member 423 away from the second fixed member 421.

It is noted that the two ends 124a, 124b of the first cord 124 freely extend through the two passing holes 21 of the top bar 20, and the two ends 424a, 424b of the third cord 424 also freely extend through the two passing holes 21 of the top bar 20.

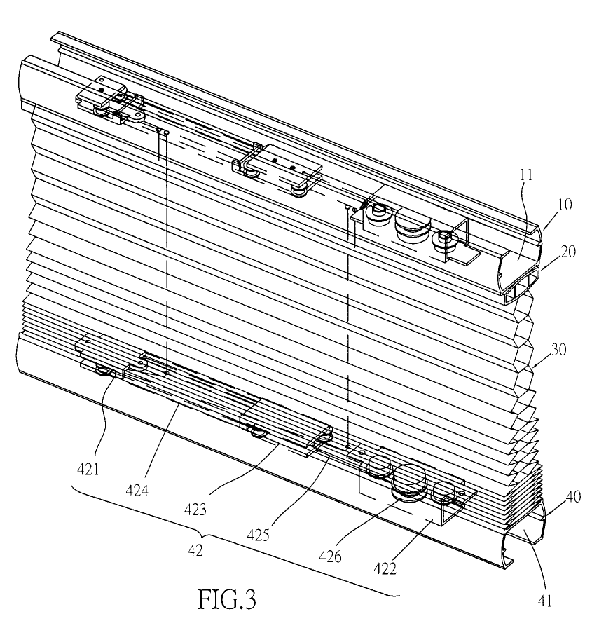

By pushing the bottom box 40 toward the top box 10, the expandable shade 30 is collected and the top bar 20 is in contact with the underside of the top box 10 as shown in FIG. 1. By pulling the bottom box 40 away from the top box 10, the expandable shade 30 is stretched and the top bar 20 is still in contact with the underside of the top box 10 and the expandable shade 30 expand as shown in FIG. 3. The user can release the bottom box 30 at desired height to set a proper open space below the bottom box 40.

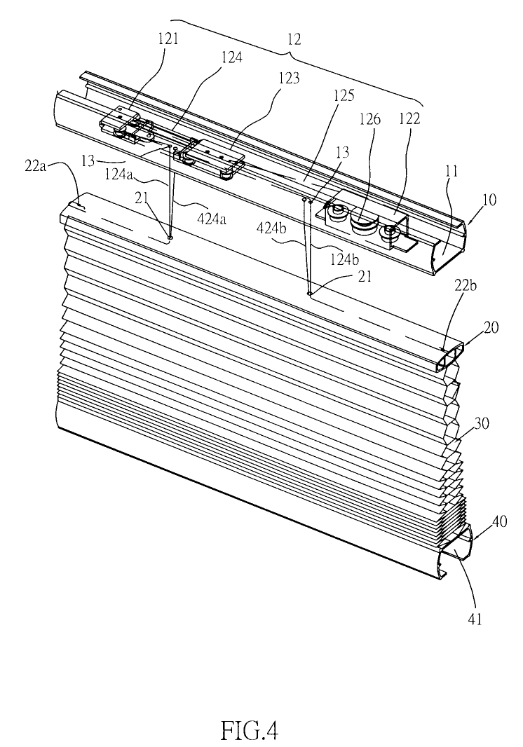

As shown in FIG. 4, when pulling the top bar 20 away from the top box 10, the top bar 20 is separated from the top box 10 and move the top end of the expandable shade 30 downward so as to define an open space between the top bar 20 and the top box 10. By this way, the curtain assembly can cover the lower portion of the window (not shown) while the users can see through the top portion of the window.

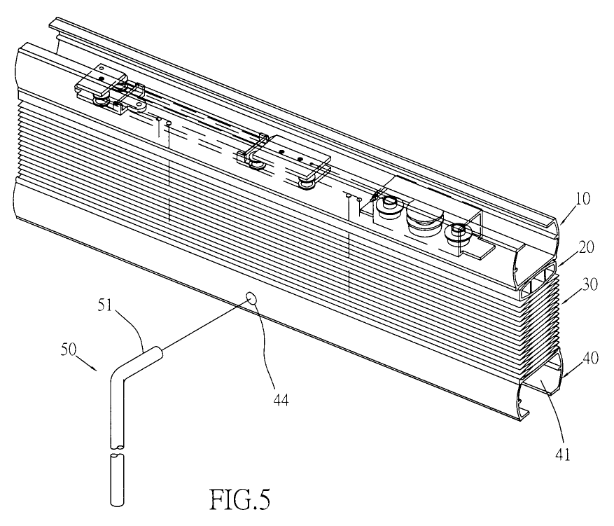

FIG. 5 shows that the bottom box 40 includes a reception hole 44 and an insertion end 51 of an L-shaped operation wand 50 can inserted into the reception hole 44 to move the bottom box 40.

While we have shown and described the embodiment in accordance with the present invention, it should be clear to those skilled in the art that further embodiments may be made without departing from the scope of the present invention.

What is claimed is:

1. A curtain assembly comprising:
a top box having a first space defined therein and a first control unit received in the first space, the first control unit including a first fixed member, a first movable member and a first control member, the fist movable member located between the first fixed member and the first control member, a first rope wrapped around pulleys in the first fixed member and the first movable member, two ends of the first rope extending through two through holes in the top box, a second rope having a first end fixed to the first movable member at a position and a second end of the second rope wrapped around a spring coil member in the first control member, the spring coil member dragging the second rope to move the movable member away from the first fixed member;
a top bar located below the top box and including a top layer and a bottom layer, two passing holes defined through the top layer and the bottom layer of the top bar respectively, the two ends of the first rope extending through the two through holes in the top box and the two passing holes in the top layer of the top bar and being fixed to two ends of the top bar;
an expandable shade having a top end fixed to an underside of the top bar and a bottom end of the expandable shade fixed to a bottom box, and
a second control unit received in a second space of the bottom box, the second control unit including a second fixed member, a second movable member and a second control member, the second movable member located between the second fixed member and the second control member, a third rope wrapped around pulleys in the second fixed member and the second movable member, two ends of the third rope extending through two second through holes in the bottom box, the expandable shade, the two passing holes in the top bar and fixed to the first through holes in the top box, a fourth rope having a first end fixed to the second movable member and a second end of the fourth rope wrapped around a second spring coil member in the second control member, the second spring coil member of the second control unit dragging the fourth rope to move the second movable member away from the second fixed member.

2. The assembly as claimed in claim 1, wherein the two ends of the first cord freely extend through the two passing holes of the top bar.

3. The assembly as claimed in claim 1, wherein the two ends of the third cord freely extend through the two passing holes of the top bar.

4. The assembly as claimed in claim 1, wherein the top bar is movable relative to the top box.

5. The assembly as claimed in claim 1, wherein the bottom box includes a reception hole and an operation wand is inserted into the reception hole.
